(19) United States
(12) Patent Application Publication
(10) Pub. No.: US 2020/0309114 A1
(43) Pub. Date: Oct. 1, 2020

(54) POPPET VALVE FOR FLUID PUMP

(71) Applicant: Q.E.D. Environmental Systems, Inc., Dexter, MI (US)

(72) Inventors: John F. SCHAUPP, East Sylvania, OH (US); David A. FISCHER, Ann Arbor, MI (US); Steven Richard WELLS, Howell, MI (US); Donald Lee SCHULTZ, Jackson, MI (US); Matthew Thomas MCKEOWN, Fowlerville, MI (US); William C. ALLEN, III, Ypsilanti, MI (US)

(73) Assignees: Q.E.D. Environmental Systems, Inc., Dexter, MI (US); Q.E.D. Environmental Systems, Inc., Dexter, MI (US)

(21) Appl. No.: 16/765,719

(22) PCT Filed: Dec. 18, 2018
(86) PCT No.: PCT/US2018/066229

§ 371 Date: May 20, 2020

Related U.S. Application Data
(60) Provisional application No. 62/607,708, filed on Dec. 19, 2017.

(51) Int. Cl. F04B 49/06; F04B 53/22

(52) U.S. Cl. CPC F04B 49/06; F16K 15/00; F04B 53/22

(57) ABSTRACT

The present disclosure relates to a pneumatically driven fluid pump apparatus having an outer pump housing for collecting liquid to be pumped, and a valve assembly in communication with liquid admitted through an inlet end of the outer pump housing and collecting within the outer pump housing. The valve assembly includes a housing assembly and a poppet valve assembly disposed within the housing assembly to act as a one-way check valve when pumping collected liquid out from the outer pump housing. The poppet valve assembly includes a poppet valve component including a relief area that helps to depressurize an interior area of the valve assembly, to facilitate rapid movement of the poppet valve element from an open position toward a closed position, when only a pressurized fluid flow being used to eject the collected liquid is flowing past the poppet valve component.

### CROSS-REFERENCE TO RELATED APPLICATIONS

This application claims the benefit of U.S. Provisional Application No. 62/607,708, filed on Dec. 19, 2017. The entire disclosure of the above application is incorporated herein by reference.

### FIELD

The present disclosure relates to fluid pumps, and more particularly to a fluid pump employing a poppet valve having a construction which effectively senses a condition where fluid flow through the valve has ceased and primarily air is flowing past the poppet valve.

### BACKGROUND

The statements in this section merely provide background information related to the present disclosure and may not constitute prior art.

Poppet valves are frequently used in fluid pumps where pressurized air is the medium used to force fluid which has entered a fluid inlet of the pump. The pressurized air is used to force the collected fluid outwardly through a fluid discharge port of the pump, during which time the poppet valve is lifted off of its seat to allow fluid to flow past it toward the fluid discharge port. Typically a float may be used to sense when the fluid level in the pump has dropped to a lower predetermined limit, at which time the pressurized air signal is turned off. At this point the poppet valve falls back onto a valve seat used in a pump housing through the force of gravity. Thus, the poppet valve controls fluid flow so that fluid can only flow in one direction (i.e., outwardly through the fluid discharge port) each time the pump is cycled through a fluid discharge operation. As the pump is re-filling with fluid the pressurized air signal is exhausted until the float indicated that a predetermined upper fluid level is reached within the pump inlet chamber, and then the above cycle is repeated. The assignee of the present disclosure is a leader in the manufacture of such types of fluid pumps.

These types of fluid pumps are often used in pumping various types of fluids (e.g., hydrocarbons, water, etc.) because no electric signal needs to be sent to the pump to achieve intermittent cycling of the pump as needed to empty the fluid collecting within the pump. However, the different types of fluids that such pumps are required to pump often can lead to contaminants being entrained in the pumped fluid, which contaminants can eventually collect on interior pump walls and interfere with the free flow of fluids through the pump and/or proper operation of the poppet valve.

With such pumps as described above, it is also desirable to be to detect, as quickly as possible, when primarily air begins flowing past the discharge poppet valve during a fluid discharge cycle. This is because it is desirable to limit the amount of air that is directed into the fluid discharge line.

### SUMMARY

In one aspect the present disclosure relates to a pneumatically driven fluid pump apparatus. The apparatus may comprise an outer pump housing for collecting liquid to be pumped, and a valve assembly in communication with liquid admitted through an inlet end of the outer pump housing and collecting within the outer pump housing. The valve assembly may include a housing assembly and a poppet valve assembly disposed within the housing assembly to act as a one-way check valve when pumping collected liquid out from the outer pump housing. The poppet valve assembly may include a poppet valve component including a relief area that helps to depressurize an interior area of the valve assembly, to facilitate rapid movement of the poppet valve element from an open position within the housing assembly toward a closed position within the housing assembly, when only a pressurized fluid flow being used to eject the collected liquid is flowing past the poppet valve component. In another aspect the present disclosure relates to a pneumatically driven fluid pump apparatus. The apparatus may comprise an outer pump housing for collecting liquid to be pumped, and a valve assembly in communication with the liquid admitted through an inlet end of the outer pump housing and collecting within the outer pump housing. The valve assembly may include a housing assembly and a poppet valve assembly disposed within the housing assembly to act as a one-way check valve when pumping collected liquid out from the outer pump housing. The poppet valve assembly may include a poppet valve component including a sealing portion and at least one relief area spaced apart from the sealing portion, downstream from the sealing portion relative to a direction of flow of the collected liquid through the valve assembly. The at least one relief area helps to depressurize an interior area of the valve assembly, to thus facilitate rapid movement of the poppet valve element from an open position within the housing assembly toward a closed position within the housing assembly, when only a pressurized fluid flow being used to eject the collected liquid is flowing past the poppet valve component.

In still another aspect the present disclosure relates to a pneumatically driven fluid pump apparatus. The apparatus may comprise an outer pump housing for collecting liquid to be pumped. A valve assembly may be included which is in communication with liquid admitted through an inlet end of the outer pump housing and collecting within the outer pump housing. The valve assembly may include a housing assembly and a poppet valve assembly disposed within the housing assembly to act as a one-way check valve when pumping collected liquid out from the outer pump housing. The poppet valve assembly may include a poppet valve component having a sealing portion at one end thereof. The housing assembly may include a first ring sealing surface and a second ring sealing surface spaced apart from the first ring sealing surface, only the first ring sealing surface making contact with the poppet valve component when the poppet valve component is in the closed position and has not experienced any appreciable wear, and then only the second ring sealing surface making contact with the poppet valve component after a wear period in which a shape of a sealing portion of the poppet valve component is altered due to wear.

In still another aspect the present disclosure relates to a method for controlling a pneumatically actuated pump. The method may include sensing a predetermined maximum level of fluid which has collected within a housing of the pump. A controller may be used to actuate a pressurized air supply to begin applying pressurized air to the pump housing to begin lifting and ejecting the fluid collected within the pump housing outwardly past a poppet valve component of a poppet valve system. The method may further include using a first poppet valve component position sensor in communication with the electronic controller to detect when the poppet valve component has initially lifted off of a sealing surface to a fully lifted position, to indicate that a discharge of fluid has begun, and to supply a first corresponding signal to the electronic controller. The method may further include using a second poppet valve component position sensor to sense when the poppet valve component has just begun to descend from the fully lifted position. The method may involve controlling the application of the pressurized air signal to the pump in an iterative process until a total pump cycle time is achieved during which descending movement of the poppet valve component from the fully lifted position is not detected while the pressurized air is being applied to the pump.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a perspective view of one example of a pump in accordance with the present disclosure;

FIG. 2 is an exploded view of various components used in a discharge valve assembly used with the pump shown in FIG. 1;

FIG. 3 is an exploded side view of the valve assembly of FIG. 3 with the poppet valve component assembled;

FIG. 4 is an enlarged side cross sectional view of the valve assembly of FIG. 3 taken substantially in accordance with section line 4-4 in FIG. 3, and showing the poppet valve component in a fully seated position;

FIG. 4A is an enlarged side cross sectional view of the lower housing of FIGS. 2 and 3 showing the dual ring sealing surfaces, as well as an alternative construction of the poppet valve component showing how the magnet may be secured within the poppet valve component using a retaining pin;

FIG. 5 shows the valve assembly of FIG. 4 with the poppet valve component in its fully raised position;

FIG. 6 shows the poppet valve component in an intermediate position where it would typically be when fluid has mostly ceased flowing past the poppet valve component and primarily air is flowing past the poppet valve component;

FIG. 7 shows how the poppet valve component wobbles when it is fully opened in response to overall shape, which helps to clean the interior wall surface of the lower valve housing;

FIG. 8 is a flowchart illustrating operations that the pump of FIG. 1 may execute as it cycles between its fully opened and fully closed conditions; and

FIG. 9 shows a cross sectional side view of another alternative construction for the poppet valve component which includes features for even more securely retaining a magnet within a body portion of the poppet valve component; and

FIG. 10 shows another embodiment of a control methodology that may be used in controlling the pump shown in FIG. 1.

Corresponding reference numerals indicate corresponding parts throughout the several views of the drawings.

### DETAILED DESCRIPTION

The following description is merely exemplary in nature and is not intended to limit the present disclosure, application, or uses. It should be understood that throughout the drawings, corresponding reference numerals indicate like or corresponding parts and features.

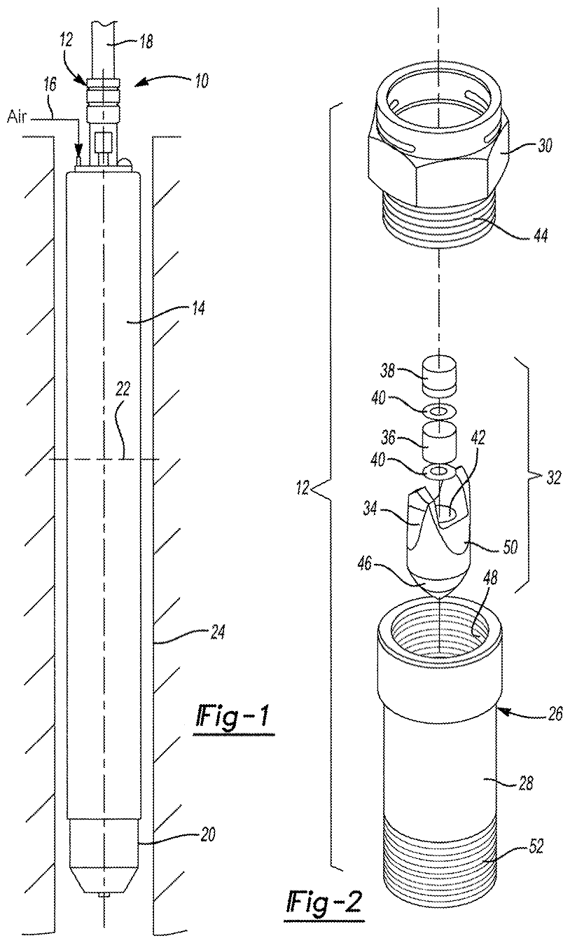

Referring to FIG. 1 there is shown a pump 10 in accordance with one embodiment of the present disclosure. In this example the pump 10 includes a poppet valve assembly 12 which is coupled to an outer pump housing 14. An inlet conduit 16 supplies pressurized fluid, in this example pressurized air, from a pressurized air source (not shown), as is well known in the industry. The poppet valve assembly 12 (hereinafter simply “valve assembly 12”) is coupled to a fluid discharge conduit 18. The pump housing 14 includes an inlet 20 which may be formed in part by a screen, which is positioned in fluid 22 within a well bore 24. The cyclical application of pressurized fluid forces fluid 22 which has entered the outer pump housing 14 to be ejected out through the valve assembly 12 and out through the fluid discharge conduit 18. This may be accomplished by using a monitoring component within the pump housing 14, for example a float (not visible), which senses when the fluid 22 has risen to a predetermined upper level and then opens an air inlet valve (not shown) operably associated with the air inlet conduit 16, or possibly by an external liquid depth measurement device which is coupled to a controller. Opening the air inlet valve allows pressurized air to flow into the interior area of the outer pump housing 14, and thus forcibly eject the collected fluid device upwardly through the valve assembly 12 and into the fluid discharge conduit 18. When the fluid level falls to a second predetermined level, this condition is sensed by the float which signals the air inlet valve to close. The valve assembly 12 forms a one-way check valve that only allows fluid flow from the interior of the outer pump housing into the fluid discharge conduit, and not in the opposite direction.

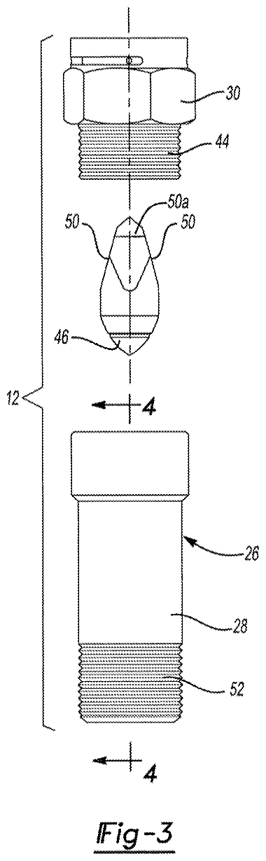

Referring to FIGS. 2-3, the valve assembly 12 can be seen in greater detail. The valve assembly 12 includes a housing assembly 26 formed by a lower housing 28 and an upper housing 30. A poppet valve assembly 32 is disposed inside the housing assembly 26 and may include a poppet valve component 34, a magnet 36, a threaded (in part) retainer screw or preseal 38, similar to an Allen screw, and O-rings 40. The magnet 36 and O-rings 40 may be secured in an axially configured bore 42 of the poppet valve component 34. The two O-rings 40 are positioned at either side of the magnet 36. These O-rings 40 act as a shock absorber. It will be appreciated that magnets, in general, are known to be somewhat brittle, and therefore are susceptible to fracturing when they experience a shock load. With the pump 10, shock loads will be encountered by the magnet 36 when the pump cycle starts and stops. A portion of the bore 42 may be threaded to enable threaded coupling with the retainer screw 38. When positioned in the bore 42, the magnet 36 is arranged adjacent a sealing portion 46 at a lower end of the poppet valve component 34.

With further reference to FIG. 2, the upper housing 30 may have a threaded portion 44 which threadably engages with a threaded portion 48 of the lower housing 28. When secured to each other, the upper and lower housings 30 and 28, respectively, capture the poppet valve assembly 32 inside the housing assembly 26 while still allowing the poppet valve assembly 32 to move freely vertically in response to a fluid flow and/or a pressurized air flow. The lower housing 28 also may include a threaded portion 52 which enables it to be threadably attached to a threaded opening (not visible in FIG. 1) in the outer housing 14 of the pump 10.

FIGS. 2 and 3 also illustrate an important feature of the poppet valve assembly 32, which is the shape and configuration of the poppet valve component 34. The poppet valve component 34 includes a first pair of inwardly tapered opposing wall portions 50, and a second pair of inwardly tapered opposing wall portions 50a (only one being visible in FIG. 3) orientated 90 degrees from the first pair of wall portions 50. The inwardly tapered opposing wall portions 50 form relief areas that help “depressurize” the interior of the valve assembly 12 when the poppet valve component 34 is lifted from its seat and begins to experience primarily a flow of air past it. This important feature will be described further in the following paragraphs.

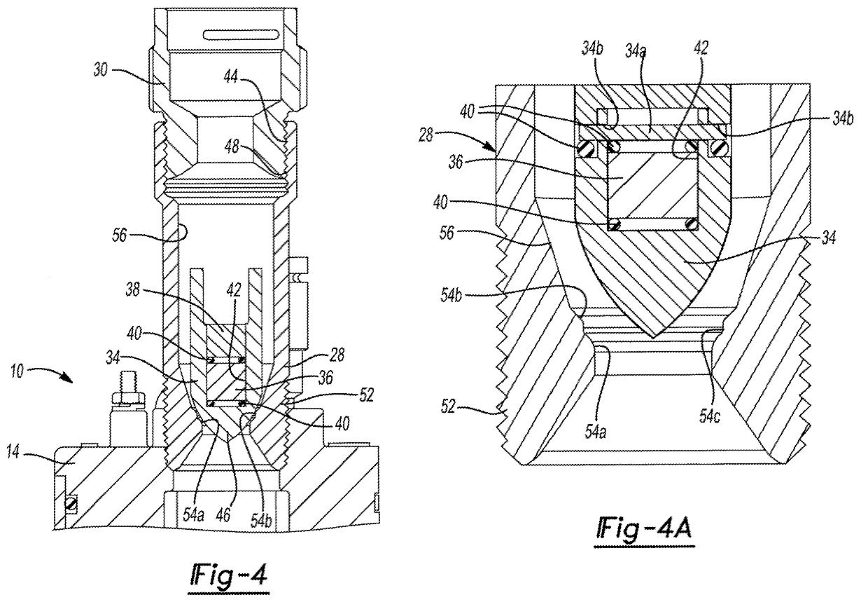

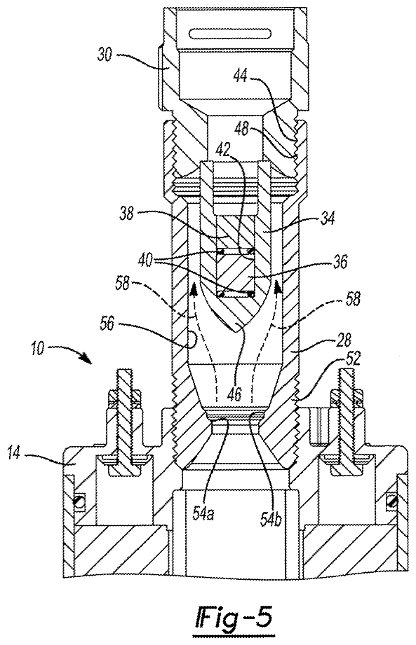

Referring briefly to FIG. 4A, the lower housing 28 of the valve assembly 12 may also include dual ring sealing surfaces 54a and 54b on an inside wall portion 56 of the lower housing. Ring sealing surface 54a may be viewed as an “initial” ring sealing surface and ring sealing surface 54b may be viewed as a “backup” or “secondary” ring sealing surface. It is typical with a single ring sealing surface poppet style valve that the one ring sealing/seating surface will initially start as a line contact area between the valve housing and the exterior surface of the poppet valve component 34. More typically, seating/sealing surfaces have a flat or smooth cone shape. The seating/sealing surface is a tangent point on the flat cone surface and an aligning tangent appoint on the cone shaped poppet valve component 34. Fluid which has been displaced into the discharge conduit 18 forms a water column having a mass that acts on the poppet valve component 34 and exerts a pressure onto the poppet valve component. This mass acts to help drive the poppet valve component 34 into its fully seated (i.e., closed) position on the initial ring sealing surface 54a inside the lower housing 28 when the pressurized air signal acting on the water column is removed. As the poppet valve component 34 tries to engage ring 54a there is a trapped volume of liquid 54c which acts as a fluid “shock absorber”. The trapped volume of liquid 54c will need to be displaced before the poppet valve component 34 can find its primary ring sealing surface 54a. This will improve the poppet valve component 34 life by reducing the shock load encountered when closing at the end of each fluid discharge cycle.

FIG. 4a also illustrates an additional feature of a press fit retaining pin 34a which extends through aligned bores 34b in the poppet valve component 34 to retain the magnet 36. The retaining pin 34a provides an additional measure of retention to ensure that the magnet 36 does not become dislodged from the poppet valve component 34.

As days and months of use go by, the contact area will slowly grow in size to a wider sealing surface. This larger sealing surface will eventually reshape (i.e., wear) the poppet valve component 34 from a cylindrical cone to what looks more like a mushroom shape. This change in shape is undesirable as it allows for water leakage around the poppet valve component 34 back into the interior of the pump outer housing 14. With a conventional style poppet valve system, once this stage of wear is reached, the pump will fail as the ejected water column above the poppet valve will slowly drain back into the pump interior housing. This failure typically requires that the poppet valve be replaced.

The dual sealing ring surfaces 54a and 54b provide a significantly longer service life for the pump 10. The initial ring sealing surface 54a is formed on the inside wall portion 56 to make contact with the poppet valve component 34 during a phase when the pump 10 is new. As the initial ring sealing surface 54a “mushrooms” and wears down over time, the displacement of material from the initial ring sealing surface 54a allows the secondary ring sealing surface 54b to then be presented to form a surface where a positive, line contact engagement can be made with the poppet valve component 34.

The time period between when the initial ring sealing surface 54a wears down to the point that the secondary ring sealing surface 54b starts to make contact with the poppet valve component 34 may vary significantly depending on a number of factors including how often the pump 10 cycles on and off, the type of fluid(s) that the pump is being used to pump, and how deep the pump 10 is placed in the wellbore (i.e., which affects the water head PSI experienced by the poppet valve component 34). But in any case, the dual ring sealing surfaces 54a and 54b are expected to significantly extend the useful life of the pump 10.

Referring again to FIGS. 4-7, the operation of the poppet valve assembly 12 will be described. Initially in FIG. 4 the poppet valve component 34 is shown in the fully closed position that it assumes when no pressurized air is being supplied through the air inlet conduit 16 to the interior of the outer pump housing 14, and no fluid is flowing past the poppet valve component 34. The poppet valve component 34 is fully seated on the initial ring sealing surface 54a because of the fluid in the fluid discharge conduit 18.

In FIG. 5 the valve assembly 12 is shown with the poppet valve component 34 in its fully raised position. Fluid is indicated by solid arrows 58. The fluid 58 flows freely around the poppet valve assembly 32 out through the valve assembly 12 into the fluid discharge conduit 18 (shown in FIG. 1 only). This is the position the poppet valve assembly 32 assumes when pressurized air is being used to eject fluid collected within the outer housing 14.

FIG. 7 shows how the poppet valve assembly 32 “wobbles” within the lower housing 28 when in its fully raised (i.e., fully opened) position. The wobbling is due in part to the outer shape of the poppet valve assembly 32, and more particularly to its conically shaped outer surface, which helps to make it unstable when positioned within a flowing fluid stream. The wobbling action is a significant benefit as it causes the poppet valve component 34 to “scrub” the inside wall surface 56 of the lower housing 28, and thus helps prevent the buildup of contaminants within the pump 10. The wobbling action also produces a vibration which is useful in helping to dislodge particles inside the pump. This is expected to help keep the pump outer housing 14, the float assembly (if included), fluid valves and the fluid discharge conduit 18 all free from contaminants.

Preventing the buildup of contaminants within pumps has heretofore been a challenge, and frequent removal of a pump from its associated well bore, along with disassembly and cleaning of the pump and/or replacement of internal parts, has typically been required. It will be appreciated that the manpower required to frequently remove, clean, repair and reinstall such pumps can introduce additional expense into the on-going operation of the pump at a given site. Such expense is expected to be significantly reduced with the pump 10 due to the design of the poppet valve assembly 32. Moreover, the shape of the poppet valve assembly 32 and the scrubbing action it provides helps to significantly reduce the buildup of contaminants within the lower housing 28 without introducing any additional parts into the pump 10, and without requiring modification to the basic design/configuration of the pump 10 and/or the valve assembly 12.

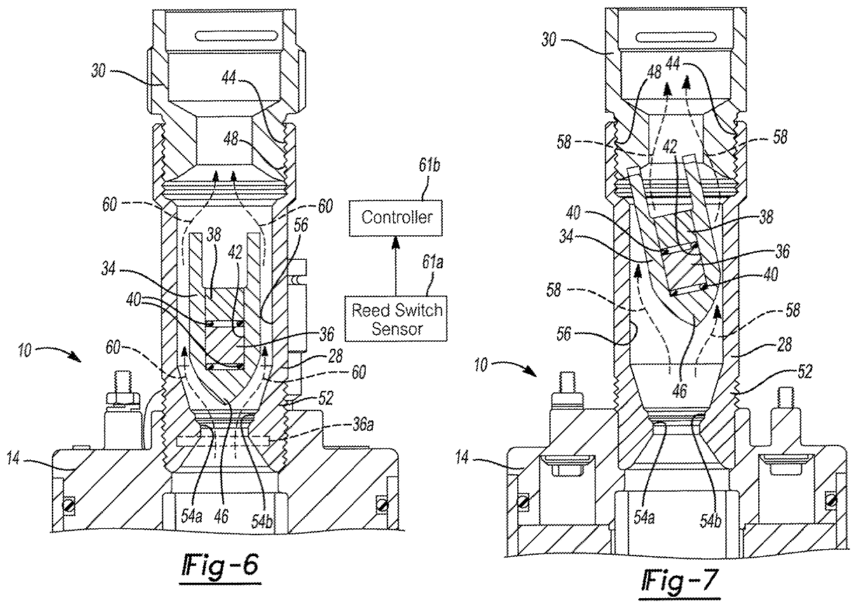

FIG. 6 illustrates the poppet valve component 34 in its intermediate position. The poppet valve component 34 assumes this position when fluid has substantially ceased flowing past the poppet valve component 34 and mostly pressurized air is flowing past the poppet valve component. In this condition, the tapered sidewalls 50 and 50a of the poppet valve component serve to depressurize the interior flow area directly aside and above the poppet valve assembly 32. This depressurized area will act to allow the poppet valve component to descend from its fully raised position into the intermediate position shown in FIG. 6. At this point the magnet 36 is positioned sufficiently close to the initial sealing surface 54a such that the poppet valve component can be magnetically drawn into contact with the initial sealing surface (assuming an additional magnet, for example optional ring magnet 36a, is used to help provide the attractive force) and therefore be re-seated in the fully closed position against the initial sealing surface. This action happens rapidly when pressurized air, indicated by dashed lines 60 in FIG. 6, becomes the dominant medium flowing past the poppet valve component. This feature is significant in reducing the amount of pressurized air that is pumped into the fluid discharge conduit 12. As will be appreciated by those skilled in the art, it is desirable to limit, as much as possible, or completely eliminate, the introduction of pressurized air into the fluid discharge conduit 18. The design of the poppet valve component 34 accomplishes this objective without requiring complex modifications to the lower housing 28 design or adding other independent components into the valve assembly 12.

As will also be appreciated, an external sensor, for example a reed switch 61a, and an electronic controller 10a, may be used to sense when the poppet valve assembly 32 has moved from its fully closed position. Optionally, two or more distinct reed switches 61a and 61b could be spaced apart elevationally to detect exactly when the poppet valve component 34 has moved into its intermediate position and/or its fully opened position. In this example reed switch 61b is used to detect when the poppet valve component 34 has moved into its uppermost position. The optional ring magnet 36a could be located adjacent to the dual ring sealing surfaces 54a and 54b and, if included, will serve to provide an enhanced closing action, which may be beneficial if contaminated fluids are being pumped which tend to hinder closing movement of the poppet valve assembly 32. It will be appreciated, however, that the magnet 36 is not essential to operation of the poppet valve assembly 32; the magnet 36 merely provides a convenient means to sense when the poppet valve assembly has moved off of its closed position, and when the poppet valve assembly has moved back into its closed position. The magnet 36 also will align the magnet's poles. This is important if a round ball with a magnet is used. The aligning would allow for a repeatable location to effect a reed switch closure, assuming a reed switch is being used to sense the location of the poppet valve assembly 32.

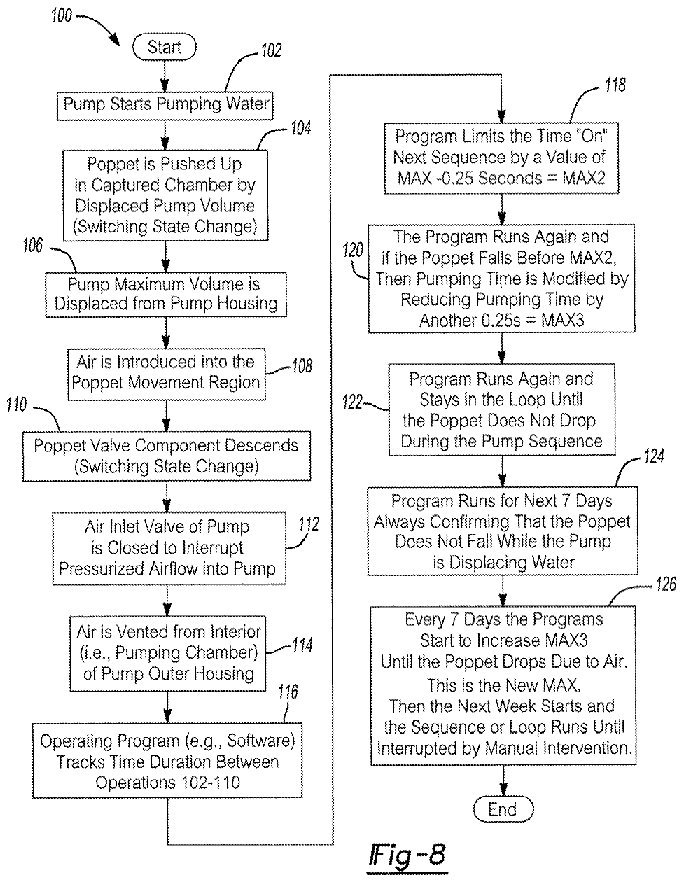

Referring to FIG. 8, a flowchart 100 illustrates a plurality of operations that may be performed by the pump 10 of FIG. 1. It will be appreciated that various ones of the following operations make reference to specific time periods, and these time periods are merely examples of suitable time periods, and may be adjusted as needed to meet the needs of a specific application/implementation. At operation 102 the pump 10 starts pumping water (or any other flowable fluid). At operation 104 the poppet valve component 34 is pushed up inside the chamber formed by the upper and lower pump housings 30 and 28 by displaced pump volume (i.e., a switch state occurs). At operation 106 the pump maximum volume is displaced from the interior volume of the pump outer housing 14. At operation 108 air is introduced into the poppet valve component 34 region of movement adjacent the upper housing 30. At operation 110 the poppet valve component 34 descends (i.e., switching state change occurs here). At operation 112 the air inlet valve of the pump 10 is closed to interrupt pressurized airflow into the pump 10. At operation 114 air is vented from the interior volume of the outer housing 14 to atmosphere. At operation 116 an operating program (i.e., software running on an electronic controller controlling the pump 10) tracks the time duration between operations 102-110. At operation 118 the operating program limits the time “ON” sequence by a value of MAX −0.25 seconds=MAX 2. This step allows the “pump” to learn or self-calibrate discharge time. This benefit is provided all the way to step 122 where the poppet valve assembly 32 is not “showing” any presence of air. At operation 120 the operating program again determines if the poppet valve component 34 falls before MAX2, and if so, modifies the pumping time by reducing pumping time by another 0.25 seconds=MAX3.

At operation 122 the operating program continues running and monitoring the poppet valve assembly 32 position until the assembly does not drop during the time that the pump 10 is actually ejecting fluid during a fluid ejection operation. At operation 124 the operating program runs for the next seven days while continuing to monitor/confirm that the poppet valve assembly 32 does not drop during a fluid ejection phase of operation (i.e., self-calibrating or “learning” how to pump the maximum amount of water without air being pumped). At operation 126, every seven days the operating program starts to increase the value of MAX3 until the poppet valve component 34 drops due to only air being present during the end of a fluid ejection cycle. This value becomes the new MAX. Then the next week starts and the sequence or loop runs until interrupted by manual intervention.

Further refinements can be made to the sequence of operation explained above in flowchart 100. Further modifications may include a separation in the operations 102 thru 104, and operations 104 thru 110, which is the pump duration cycle. The two parts would allow for system dependent variables to be measured, for example pump depth and true pumping time. The true pumping time could be used to better estimate the total number of gallons pumped by identifying the time range between operations 104 to 110.

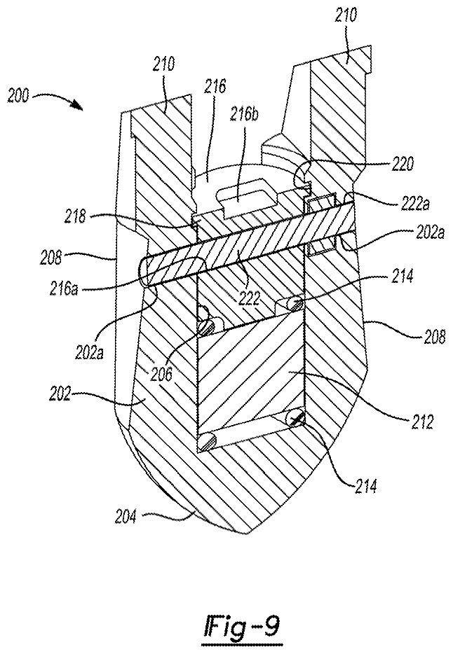

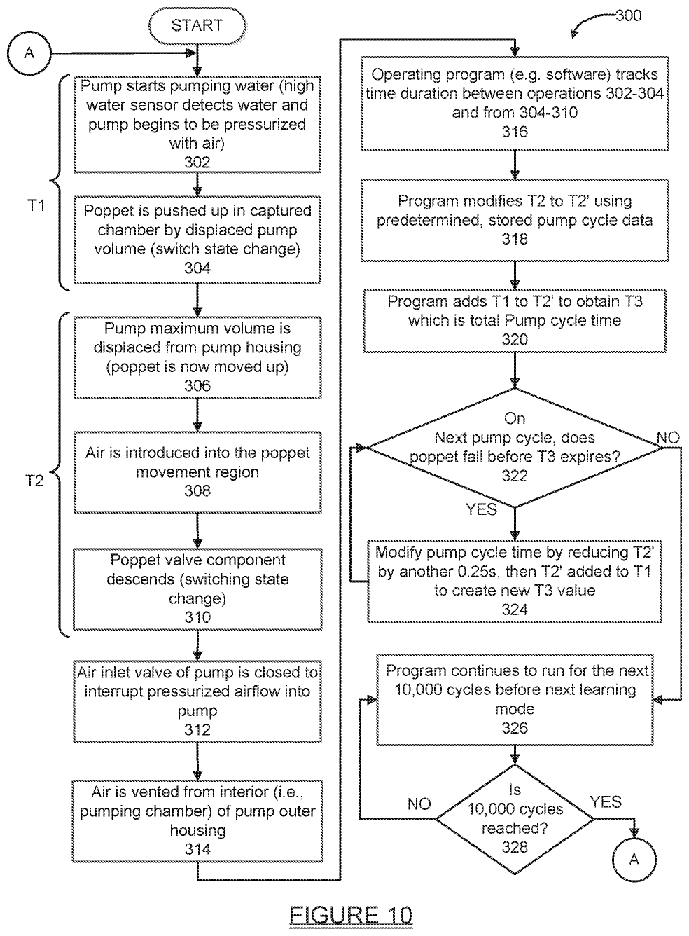

Referring further to FIG. 9, a poppet valve component 200 is shown in accordance with another embodiment of the present disclosure. The poppet valve component 200 in this example includes a body portion 202 having a conical (i.e., bullet-shaped) sealing portion 204 at one end. At an opposite end a bore 206 is formed. A pair of inwardly tapering, wall portions 208 are arranged on circumferentially opposing portions of the body portion 202. The operation of these tapering wall portions 208 is as described for the inwardly tapering wall portions 50 and 50a of the poppet valve component 34. The body portion 202 similarly includes wing portions 210 which allow fluid being ejected to flow between them and around them.

The poppet valve component 200 includes a dual retention configuration for a magnet 212 which is disposed within the bore 206. As with the poppet valve component 34, a pair of O-rings 214 may be used to absorb the shock load experienced by the magnet 212 when the poppet valve component 200 moves from an open position to a closed position, or from a closed position to an open position. However, instead of a threaded retention screw, the poppet valve component 200 incorporates a press-fit retention element 216 which is press fit into the bore 206 such that a shoulder portion 218 thereof engages within a circumferential groove 220 in the bore 206. This forms a first retention feature. A second retention feature is formed by a pin 222 which is press fit into a bore 216a in the retention element 216, and through bores 202a in the body portion 202. The pin 222 may include at least one raised portion 222a to further aid in retaining it in the bores 202a.

To aid in aligning the bore 216a with the bores 202a, the retaining element 216 may include a keyed (e.g., square shaped or rectangular shaped) depression 216b. The keyed depression 216b may be orientated parallel to the longitudinal axis of the bore 216a so that a visual alignment of the retaining element 216 may be made during assembly when the retaining element is press fit into the body portion 202.

The two retention features described above are important because they help to ensure against the magnet 212 becoming dislodged from the bore 206 during repeated opening and closing of the poppet valve component 200. This can significantly reduce or eliminate the damage that may occur internally to a pump if the magnet 212 were to become free to move within the bore 216 during operation of the pump.

Referring to FIG. 10, a flowchart 300 is presented which illustrates high level operations that may be performed in implementing another control methodology for controlling the pump 10. The methodology shown in FIG. 10 begins at operation 302 when the pump 10 starts to pump water. With brief reference to FIG. 1, in this regard it will be appreciated that the pump 10 makes use of a conventional “high” water sensor S1, which detects when water collecting within the pump 10 has reached a predetermined upper level, as well when the water in the well has reached a predetermined minimum level. Sensor S1 reports its electrical signals to the electronic controller 10a. The electronic controller 10a uses the information from sensor S1 to control the ON/OFF operation of a pressurized air source 10b. This control may be achieved through the use of known pump performance data that is held in a look-up table or chart 10d which is stored in a memory 10c of the electronic controller, or a separate memory component which is accessible by the electronic controller 10a.

In this example, at operation 302, the sensor S1 has reported a “high water” signal to the electronic controller 10a and the electronic controller 10a has turned on the pressurized air source 10b to begin applying pressurized air through the air line 16 to the pump 10. At operation 304 the poppet valve component 34 has been lifted up inside the lower housing 28 by the displaced water volume which is beginning to be ejected past the poppet valve component 34 using the pressurized air flow. The fully raised condition of the poppet valve component 34 is detected by the reed switch 61b (FIG. 6) (or other Hall Effect sensor or I2C sensor), which generates a signal in accordance therewith. Operations 302 and 304 together define a timer interval “T1” which represents the time it takes for the pump 10 to become pressurized and begin pumping water. Thus, T1 takes into account a large number of variables, for example and without limitation, the length and cross-sectional internal diameter of tubing being used to supply the pressurized air signal to the pump 10, the number and types of fittings, elbows, and/or partially kinked areas of the air supply line, any partially frozen sections of the airline, any undersized portion(s) of the air line, and/or compressor capacity.

With further reference to FIG. 10, at operation 306, the pump 10 maximum volume is displaced from the pump housing, meaning the maximum amount of water that the pump can displace in a given eject cycle of the pump 10. At operation 308 pressurized air just begins to be introduced into the poppet valve component 34 region of movement (i.e., within the lower housing 28). When this occurs, the construction of the poppet valve component 34 enables it to respond virtually immediately and begin to descend, which is indicated at operation 310. Together operations 306-310 define a time interval “T2”, which may be viewed as a total pumping time between when water just begins to be pushed up out from the lower pump housing 28 to when the poppet valve component 34 just begins to descend from its raised position. As the poppet valve component 34 just begins to descend, it will generate a signal indicating this condition to the electronic controller 10a. The initial descending movement of the poppet valve component 34 signals the end of interval T2, which also indicates that air has just now started to flow past the poppet valve component 34.

At operation 312 the air inlet valve (not shown) supplying pressurized air to the pump 10 is closed to interrupt the flow of the pressurized airflow into the pump 312. At operation 314 air is then vented from the interior of the pump casing 14 (i.e., the pump's pumping chamber). At operation 316 an operating program 10e running in the electronic controller memory 10c tracks the time duration T1 (i.e., from operations 302-304) and the time duration T2 (i.e., from operations 304-310). At operation 318 the operating program 10e modifies T2 to T2′ by using stored, known pump performance data from the look-up table 10d. T2′ thus represents a time duration value that takes into account various factors that may affect pump performance, and more precisely the cycle time for the pump to fully eject a predetermined maximum quantity of fluid during a single pump cycle (e.g., fluid temperature, type of fluid being pumped, etc.). The time duration T2′ therefore is a time duration which is less than T2, and represents the amount of time required to pump the maximum amount of water without pumping any air past the poppet valve component 34.

At operation 320, the operating program 10e than adds T1 to T2′ to obtain time duration T3. Time duration T3 represents a total pump cycle time, which includes all the variables described which affect pressurization of the pump 10, as well as the time it takes to move the maximum quantity of water (or other fluid) out from the pump housing 14, which may also be viewed collectively as the total “pump cycle” time.

At operation 322, on the very next pump cycle, a check is made by the electronic controller 10a if the poppet valve component 34 starts to descend from its fully raised position before T3 has expired. If the answer to this inquiry is “No”, then no further adjustments to T2′ are needed, and the electronic controller 10a continues to use the current value for T3 in controlling cycling of the pump 10. At operation, 326, the program 10e continues to count the pump cycles executed cycle as the pump 10 continues to operate. At operation 328 a check is made if a predetermined number of pump cycles, for example 10,000 pump cycles, has been reached, and if not, normal pump operation continues at operation 326. If the check at operation 328 indicates that 10,000 pump cycles has been reached, then the operating program 10e loops back to operation 302 to repeat operations 302-322.

If the check at operation 322 indicated that the poppet valve component 34 was detected as beginning to fall from its raised position (indicating air is now flowing past the poppet valve component 34) before T3 has expired, then the electronic controller 10a modifies T2′ by reducing it by a fixed time value, for example 0.25 seconds. It then adds the new value of T2′ to T1 to create a new value for T3. Operation 322 is then repeated to check if during the following pump cycle, the poppet valve component 34 begins to descend from its fully lifted position before T3 has expired, and if so operation 324 is repeated. Operations 322 and 324 are repeated until the inquiry at operation 322 produces a “No” answer.

The methodology described in connection with flowchart 300 is unique in that achieves a level of control over the pump cycling which virtually eliminates the introduction of pressurized air into the fluid discharge conduit 18 at the very end of a pump eject cycle, which as will be appreciated is a highly undesirable event. The methodology described in FIG. 10 does not rely on estimates or guesses as to when pressurized air is beginning to move into the discharge line; rather this condition is reliably detected and the pressurized air supply is controlled by the electronic controller 10a, in accordance with known pump performance characteristics, so that the pressurized air signal is removed before the poppet valve component 34 begins to experience a flow of air past its outer surfaces.

The pump 10 construction is expected to significantly reduce operating costs due to its ability to effecting a scrubbing action on the interior of the pump 10 housing during every fluid ejection cycle. The dual ring sealing surfaces 54a and 54b further extend the intervals between needed pump servicing by two distinct ring sealing surfaces that are used as the internal wall surfaces of the lower housing 28 wear. It is a particular advantage that no disassembly of the pump is needed to re-configure the pump to use the secondary ring sealing surface 54b; the use of this sealing surface comes into play automatically when the initial ring sealing surface 54a experiences a predetermined level of wear.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A pneumatically driven fluid pump apparatus comprising:
an outer pump housing for collecting liquid to be pumped;
a valve assembly in communication with liquid admitted through an inlet end of the outer pump housing and collecting within the outer pump housing;
the valve assembly including:
a housing assembly; and
a poppet valve assembly disposed within the housing assembly to act as a one-way check valve when pumping collected liquid out from the outer pump housing;
the poppet valve assembly including a poppet valve component including a relief area that helps to depressurize an interior area of the valve assembly, to facilitate rapid movement of the poppet valve component from an open position within the housing assembly toward a closed position within the housing assembly, when only a pressurized fluid flow being used to eject the collected liquid is flowing past the poppet valve component.

2. The apparatus of claim 1, wherein the relief area includes at least one tapering wall portion formed on the poppet valve component.

3. The apparatus of claim 1, wherein the relief area includes a pair of tapering wall portions formed on opposing sides of the poppet valve component.

4. The apparatus of claim 1, wherein the poppet valve component comprises a sealing portion at one end thereof, and wherein the relief portion is spaced from the sealing portion.

5. The apparatus of claim 4, wherein the relief portion comprises a pair of inwardly tapering wall portions, both of which are spaced from the sealing portion.

6. The apparatus of claim 5, wherein the inwardly tapering wall portions are arranged on opposing sides of the poppet valve component.

7. The apparatus of claim 1, wherein the poppet valve component includes a bore, and a magnet disposed in the bore, the magnet assisting in urging the poppet valve component into a closed orientation relative to the housing assembly.

8. The apparatus of claim 7, further comprising an O-ring positioned in the bore and in contact with the magnet to act as a shock absorber to cushion a shock load experienced by the magnet during at least one of opening and closing of the poppet valve component.

9. The apparatus of claim 8, further comprising a retainer component for securing the magnet within the bore.

10.-26. (canceled)

27. The apparatus of claim 7, further comprising a pair of O-rings positioned in the bore and in contact with opposing sides of the magnet to act as a shock absorber to cushion a shock load experience by the magnet during both opening and closing movements of the poppet valve component.

28. The apparatus of claim 9, further comprising a retainer component for securing the magnet within the bore.

29. The apparatus of claim 1, wherein the housing assembly comprises a lower housing and an upper housing secured together, with the poppet valve assembly enclosed between the upper and lower housings.

30. The apparatus of claim 1, wherein the housing assembly includes a first ring sealing surface and a second ring sealing surface spaced apart from the first ring sealing surface, only the first ring sealing surface making contact with the poppet valve component when the poppet valve component is in the closed position and the poppet valve component has not experienced any appreciable wear, and then only the second ring sealing surface making contact with the poppet valve component only after a wear period in which a shape of a sealing portion of the poppet valve component is altered due to wear.

31. A method for controlling a pneumatically actuated pump, comprising:
sensing when a predetermined maximum level of fluid has collected within a housing of the pump;
when the predetermined maximum level of fluid is detected, using a controller to actuate a pressurized air supply to begin applying pressurized air to the pump housing to begin lifting and ejecting the fluid collected within the pump housing outwardly past a poppet valve component of a poppet valve system;
using a first poppet valve component position sensor in communication with the controller to detect when the poppet valve component has initially lifted off of a sealing surface of the poppet valve system to a fully lifted position, to indicate that a discharge of fluid has begun, and to supply a first corresponding signal to the controller;
using a second poppet valve component position sensor to sense when the poppet valve component has just begun to descend from the fully lifted position, and
adjusting a total duration of the application of the pressurized air signal to the pump until a total pump cycle time is achieved during which descending movement of the poppet valve component from the fully lifted position is not detected while the pressurized air is being applied to the pump.

32. The method of claim 31, further comprising using the controller to determine a variable T1, wherein T1 represents a time duration between when the controller applies a signal to start a pump cycle to when the poppet valve component is detected as initially having moved from a fully lowered position, indicating fluid has begun to flow past the poppet valve component out from the pump housing.

33. The method of claim 32, further comprising using the controller to determine a variable T2, wherein T2 represents a time duration between when the poppet valve component has been detected as being lifted from the fully lowered position to when the poppet valve component begins to drop from the fully lifted position.
